(19) United States
(12) Patent Application Publication
(10) Pub. No.: US 2010/0014704 A1
(43) Pub. Date: Jan. 21, 2010

(54) SPHERICAL SPEAKER

(76) Inventors: Rainer Goschin, Berlin (DE); Gert Haeder, Hohen Neuendorf (DE); Henry Loch, Forderstedt (DE)

Correspondence Address: KENYON & KENYON LLP, ONE BROADWAY, NEW YORK, NY, 10004, US

(21) Appl. No.: 12/299,485

(22) PCT Filed: May 2, 2007
(86) PCT No.: PCT/EP2007/054245

§ 371 Date: May 6, 2009

(30) Foreign Application Priority Data
May 8, 2006 (DE) 10 2006 021 552.4

(51) Int. Cl. H04R 1/00

(52) U.S. Cl. 381/400

(57) ABSTRACT

A spherical speaker has a spherical diaphragm, a moving coil, and a magnet. To improve the sound quality of the spherical speaker, the magnet is a disk magnet and the spherical diaphragm is divided into an internal area and an external area.

### FIELD OF THE INVENTION

The present invention relates to a spherical speaker having a spherical diaphragm, a moving coil, and a magnet.

### BACKGROUND INFORMATION

With the aid of a vibrating diaphragm, speakers generate sound waves which propagate in air. The diaphragm may have different shapes as a function of the speaker size and the sound pressure to be generated, among other things. A spherical diaphragm, i.e., a section of a spherical surface, offers the advantage that, due to its spherical shape, it is relatively rigid, yet has a large angle of radiation of the generated sound waves. However, spherical diaphragms of this type made, for example, of plastic, a fabric, or metal, cannot be designed in any size because the rigidity of the diaphragm having a reasonable weight cannot be infinitely increased.

A magnet is used, in particular a ring magnet in high-quality speakers, to induce vibrations in the diaphragm. Using this ring magnet, a magnetic field is generated, which, interacting with a moving coil which also has current flowing through it, causes the actual diaphragm movement. Sound volume, i.e., sound pressure and frequency of the generated sound waves are generated according to the current flow.

It is considered a disadvantage here that a natural resonance of spherical speakers, in particular of compact speakers, which are used in audio systems of motor vehicles, is often in the audible middle tone range of the audio system, so that undesirable audible sound impairment occurs.

### SUMMARY

An object of the present invention is to provide a spherical speaker of the above-mentioned type which has improved sound quality despite its compact design.

In accordance with the present invention, on the one hand, not a ring magnet, but a disk-shaped magnet is used as the magnet interacting with the moving coil. On the other hand, the spherical diaphragm is divided into an internal and an external area. This makes a more compact design possible because disk magnets have a smaller diameter than ring magnets which must surround the moving coil. The internal area of the spherical diaphragm functions as a conventional spherical diaphragm, and the external area functions as both a ring emitter and a bead, i.e., as a transition between the internal diaphragm area and, for example, a metallic or plastic speaker basket. Due to the effective double volumes in the internal and external areas, more complex impedance curves may be implemented to improve the transmission properties in the resonance range.

An advantage of an example embodiment of the present invention is that, due to the external area functioning as a ring emitter, the omnidirectional characteristic of the speaker is improved in comparison with conventional speakers having, for example, a conical diaphragm. The transition between internal and external areas is formed by a bobbin on which the diaphragm is situated and which stabilizes the diaphragm, thus reducing partial resonance in particular. The effective acoustic surface area of the speaker, i.e., the diaphragm, is thus increased, mainly toward the high frequencies. The efficiency is also increased because less energy is converted into heat due to the deformation of the diaphragm.

In one embodiment, a neodymium magnet is advantageously used as the disk magnet. Magnets of this type are characterized by high field strengths and a compact magnet size.

To improve the sound quality, a ferrofluid may be introduced into an air gap between the disk magnet and the coil. Depending on the viscosity of the ferrofluid, the moving coil is dampened but, due to the design of the speaker, this has no major effect on the dampening in the transmission range because a natural resonance in the lower range may be achieved via the described measures. By using a first-order high-pass filter, this in turn produces a greater distance to excessive natural resonance in the set transmission range. This results in a clean sound pattern and lower temperature values under load.

In accordance with one embodiment, a bobbin neck is perforated for exchanging air between the internal and external areas. Due to the specified dimensions, which are defined, for example, by an installation of the speaker into a dashboard of a motor vehicle, a defined ventilation between the internal volume underneath the internal area of the spherical diaphragm and the external volume underneath the external area of the spherical diaphragm may be achieved via holes or hole groups in the bobbin neck. This air exchange allows substantially lower natural resonance to be achieved, which then no longer impairs the sound pattern, in particular in high-pass operation. Since, especially, in motor vehicles, the high-pass filters used are formed only by a single economically advantageous capacitor, considerable improvement in the sound quality may be achieved using a speaker of this type.

In accordance with one embodiment of the present invention, the external area of the spherical diaphragm is provided with trimmings. These may be, for example, trimmings to improve the appearance of the speaker. In principle, this external area may also be integrated into door or dashboard linings, to obtain a defined acoustically tuned operating volume of the spherical speaker despite its small installed dimensions.

The acoustically tuned operating volume of the spherical speaker may be obtained, according to one example embodiment, using an additional support plate and/or a cap, and/or an external molding. The external area of the spherical speaker is advantageously provided with an enclosed support plate and/or a cap. Furthermore, the external area may be joined with any molding to form a defined internal volume which determines the acoustic parameters.

### BRIEF DESCRIPTION OF THE DRAWINGS

Specific example embodiments of the present invention are explained below in greater detail with reference to the figures.

FIG. 1 schematically shows a spherical speaker.

FIGS. 2 through 5 show further specific example embodiments of the spherical speaker.

### DETAILED DESCRIPTION OF EXAMPLE EMBODIMENTS

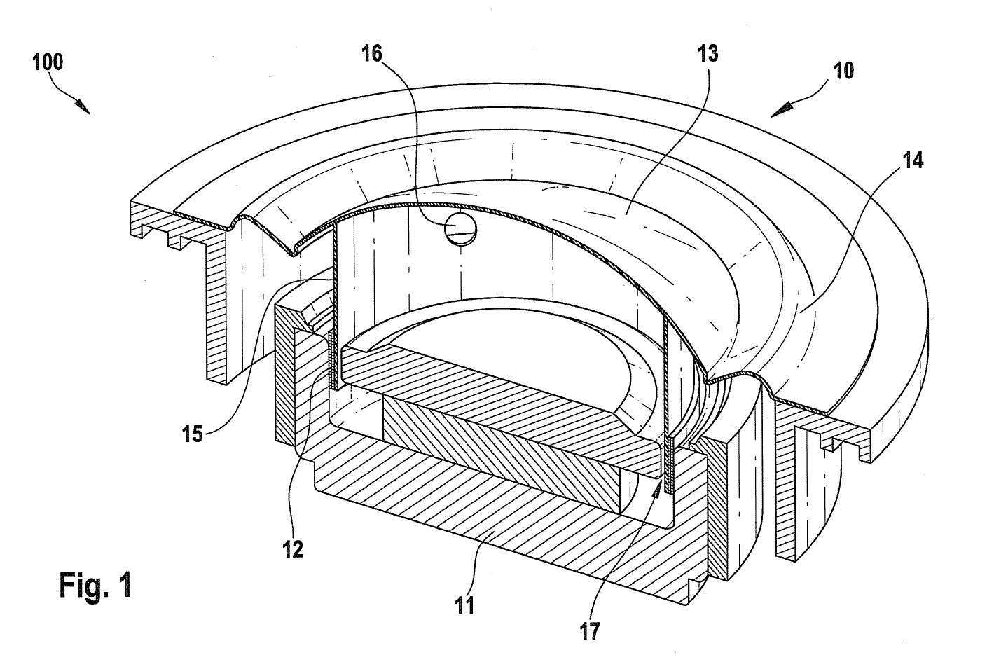

FIG. 1 shows a spherical speaker 100. It has a spherical diaphragm 10 made of suitable conventional materials. Spherical diaphragm 10 is made to vibrate with the aid of a moving coil 12 for generating sound waves. Moving coil 12 cooperates with a disk magnet 11, preferably a neodymium magnet, whose external dimensions may be selected to be much smaller than those of a ring magnet surrounding moving coil 12.

Spherical diaphragm 10 is furthermore divided into an internal area 13 and an external area 14, the division being achieved by a bobbin neck 15, which engages spherical diaphragm 10 from below.

To improve the sound quality of spherical speaker 100, bobbin neck 15 is perforated 16, i.e., provided with different hole groups to obtain an air exchange between the internal volume underneath internal area 13 of spherical diaphragm 10 and the external volume underneath external area 14 of spherical diaphragm 10.

External area 14 functions as a ring emitter and a bead. The omnidirectional characteristic is thus considerably improved compared to conventional speakers. Internal area 13 of spherical diaphragm 10 functions almost as a normal spherical speaker.

Furthermore, a ferrofluid may be introduced, in a conventional manner, in an air gap 17 between moving coil 12 and disk magnet 11.

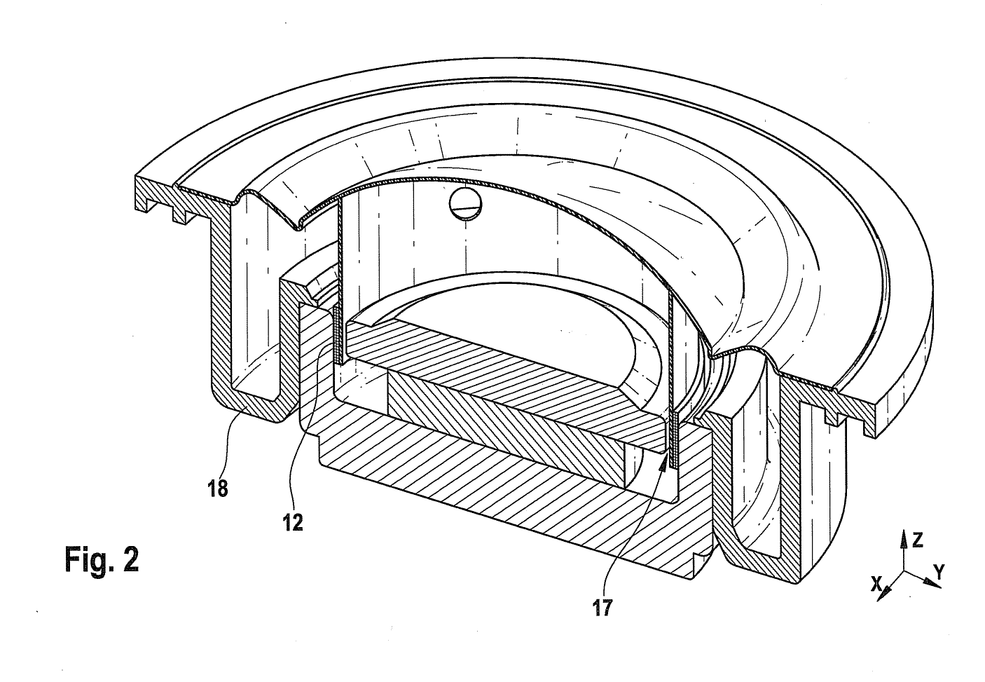

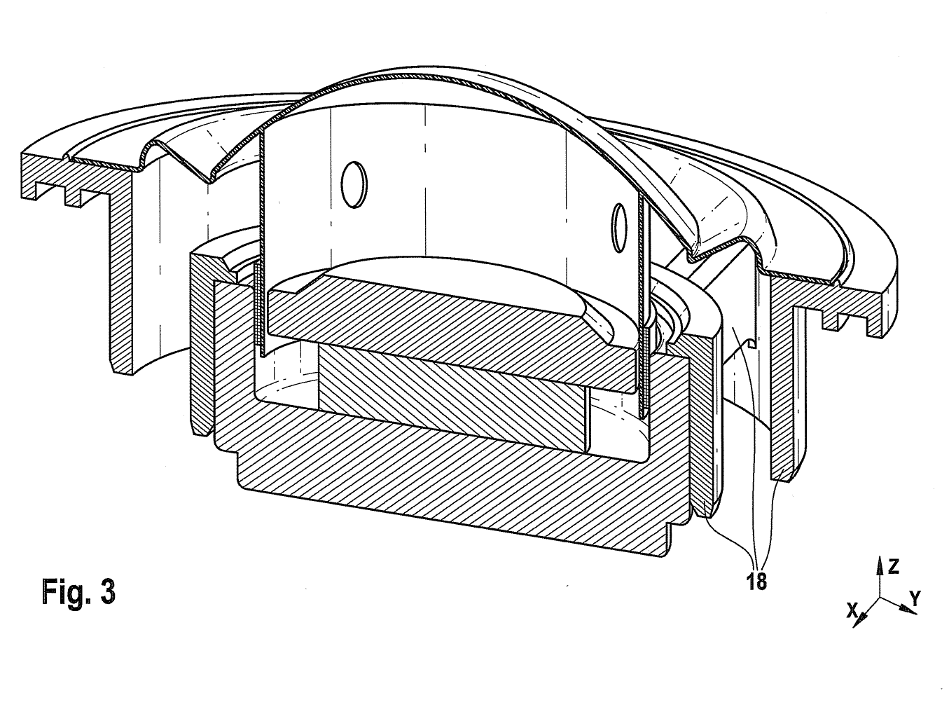

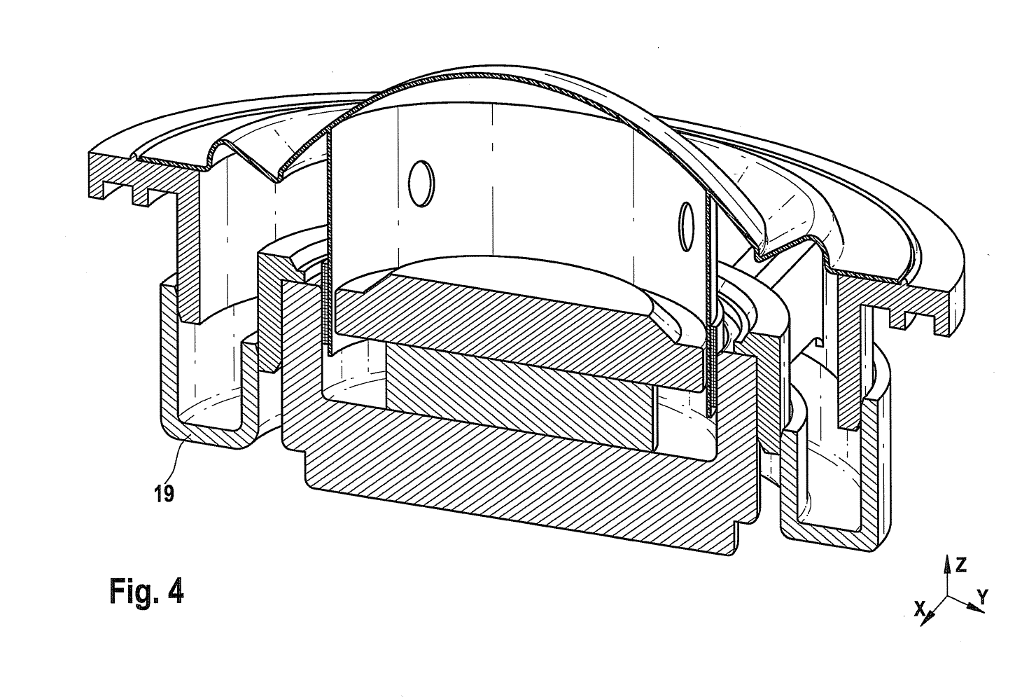

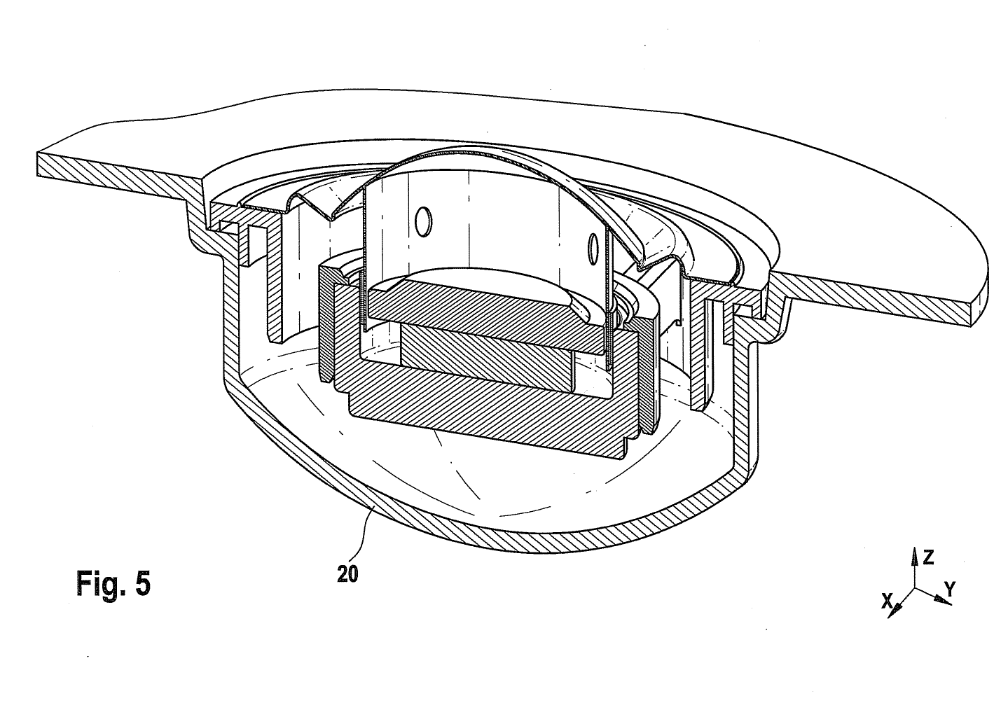

To achieve an acoustically tuned internal volume, a support plate 18, a cap 19, or any external molding 20 may be provided for spherical speaker 100 as an alternative, in particular in its external area 14 as shown in FIGS. 2 through 5.

1-6. (canceled)

7. A spherical speaker, comprising:
a spherical diaphragm;
a moving coil; and
a magnet, the moving coil being situated between the spherical diaphragm and the magnet;
wherein the magnet is a disk magnet and the spherical diaphragm is divided into an internal area and an external area.

8. The spherical speaker as recited in claim 7, wherein the disk magnet is a neodymium magnet.

9. The spherical speaker as recited in claim 7, wherein a ferrofluid is in an air gap between moving coil and disk magnet.

10. The spherical speaker as recited in claim 7, further comprising:
a perforated bobbin neck adjacent to the spherical diaphragm.

11. The spherical speaker as recited in claim 7, wherein the external area has trimmings.

12. The spherical speaker as recited in claim 7, wherein the spherical speaker is provided with at least one of a support plate, a cap, and an external molding.
